(19) United States
(12) Patent Application Publication
(10) Pub. No.: US 2014/0278795 A1
(43) Pub. Date: Sep. 18, 2014

(54) SYSTEMS AND METHODS TO PREDICT PURCHASING BEHAVIOR

(71) Applicants: Subramaniam Satyamoorthy, Palm Harbor, FL (US); Stephen P. Mooney, San Mateo, CA (US); William McGivern.Smith, Chicago, IL (US); Kyle Gerhart, St. Charles, IL (US)

(72) Inventors: Subramaniam Satyamoorthy, Palm Harbor, FL (US); Stephen P. Mooney, San Mateo, CA (US); William McGivern.Smith, Chicago, IL (US); Kyle Gerhart, St. Charles, IL (US)

(21) Appl. No.: 13/801,401

(22) Filed: Mar. 13, 2013

(51) Int. Cl. G06Q 30/02

(52) U.S. Cl. CPC G06Q 30/0201
USPC 705/7.33; 705/7.29

(57) ABSTRACT

Example methods, systems, and computer readable storage media to predict purchasing behavior are disclosed. A disclosed example method includes creating a model based on first purchase data and demographic information. The first purchase data and demographic information is associated with panelists. The first purchase data is collected via both a home scanning system and via a frequent shopper system. The example method includes applying the model to consumer data to predict second purchase data. The consumer data corresponds to consumers participating in the frequent shopper system who are not panelists of the home scanning system. The example method includes creating a report based on the second purchase data.

### FIELD OF THE DISCLOSURE

The present disclosure relates generally to purchasing behavior and, more particularly, to systems and methods to predict purchasing behavior.

### BACKGROUND

Producers of goods and/or services find value in determining behaviors of consumers so that marketing, design, and/or distribution efforts of such goods and/or services may be tailored to achieve improved market penetration. Such efforts may be through one or more channels such as wholesalers, retailers, Internet websites, radio and/or television (e.g., terrestrial television, cable television, satellite television, Internet streaming, and/or advertisers associated with any of the foregoing). Generally speaking, if a producer, designer, and/or manufacturer understands, for example, consumer purchasing behavior, then factors related to the success and/or failure of marketing efforts may be identified and possibly improved upon.

### BRIEF DESCRIPTION OF THE DRAWINGS

FIG. 1 illustrates an example system implemented in accordance with the teachings of this disclosure to predict purchasing behavior.

FIG. 2 illustrates an example implementation of the purchase modeler of FIG. 1.

FIG. 3 is a flow diagram representative of example machine readable instructions that may be executed to implement the example purchase modeler of FIGS. 1 and/or 2.

FIG. 4 is another flow diagram representative of example machine readable instructions that may be executed to implement the example purchase modeler of FIGS. 1 and/or 2.

FIG. 5 is a block diagram of an example processor platform that may be used to execute the instructions of FIGS. 3 and/or 4 to implement the example purchase modeler 102 of FIGS. 1 and/or 2.

### DETAILED DESCRIPTION

Consumer purchasing behavior is typically studied by collecting purchasing information associated with a number of consumers (e.g., panelists, respondents, etc.). Often, a research entity will register consumers or panelists. Such panelists typically provide demographic information and agree to have one or more aspects (e.g., purchasing behavior, media exposure behavior, etc.) of their behavior monitored. The data collected from such panelists may be used to statistically project purchasing behavior to one or more larger groups of consumers. Consumer purchasing data may be collected, analyzed, and/or used to target advertising to effect purchasing behavior in future consumers.

Panelists are typically selected to represent one or more particular geographic and/or demographic aspects of a universe. These panelists who agree to participate in a study provide this demographic information to the entity conducting the study through a registration process. Consumer behavior(s) are analyzed based on one or more metrics. Example consumer sales metrics include volume, population, penetration, transactions per buyer, and/or volume per transaction. The volume metric represents the total number of units sold. The population metric represents a size of the total pool from which purchasers are drawn. The penetration metric represents a percentage of the total population that purchases a product within a time period. The transactions per buyer metric represents an average number of distinct purchase occasions in a period. The volume per transaction metric represents an average purchase size in the time period.

Based on the collected panelist data, projections may be made to determine values (e.g., one or more consumer sales metrics) for a larger universe of consumers. A high degree of confidence may be placed on the projections made from panelist data because the collected data is robust, reliable, and/or detailed.

Purchasing information may be collected in a variety of ways. For example, purchasing information may be collected from consumers who consent to participate in one or more panels monitored by a market research entity for the purpose of market research. A home scanning system (e.g., a Nielsen Homescan® purchase data collection service) allows panel members to scan barcodes associated with purchased goods at their respective homes. Panelists may use the home scanning system to scan barcodes associated with purchased items (e.g., using bar codes, SKUs, etc.) at home, regardless of where such purchases were made (e.g., stores, online, mail orders, etc.). Typically, the panelist is also asked to enter (e.g., with a keypad) an identifier of a channel associated with the products (e.g., an identifier of the store at which the purchase occurred). Because purchase data may be collected from a variety of different sources, the purchase data collected by the home scanning system provides breadth in terms of representation of the purchases of the population. However, the home scanning system is often costly, and relies on panelists to independently scan their purchases. Accordingly, some purchases may not be tracked (e.g., panelist failure to scan), may be over tracked (e.g., counted more times than purchases were actually made), may be under tracked (e.g., counted fewer times than purchases were actually made), etc. Furthermore, due to the cost of the home scanning systems, fewer panelists may be tracked when compared with other methods of consumer tracking.

In some examples, purchasing information is collected from registered users of rewards programs or other services that are not advertised as being for the express purpose of market research, but that track purchasing behavior of such registered users. For example, data may be collected from transaction log data from loyalty card programs (e.g., frequent shopper card programs). Frequent shopper card programs are available in increasing numbers and cost measurement companies little when compared to panels and/or home scanning systems. For example, loyalty card programs from a grocery store/chain are widely available. Grocery stores grant a user a loyalty card, for example, that may be presented during check-out and entitle the respondent to one or more discounts. Each purchase made with the loyalty card is captured (e.g., via bar codes, SKUs, etc.) to learn which items were purchased, purchase quantities, and a date of purchase. Because the loyalty card is associated with a particular store or seller, location of sale and/or channel may also be collected. Typically, participants in loyalty card programs are asked to provide demographic information when registering for the loyalty card. As a result, data collected with the loyalty card may be associated with the user's name, address, and/or other personal (e.g., demographic) information. Because purchase information is collected at the store at the time of purchase, the purchase data collected using frequent shopper cards (i.e., loyalty cards) is generally accurate, reliable, and robust.

In some examples disclosed herein, panelists utilizing the home scanning system are also registered users of frequent shopper card programs. Purchase data collected from such panelists that also use frequent shopper card programs is useful as the data reflects which items were purchased at a particular store (e.g., using a frequent shopper card) and which items were purchased (e.g., based on home scans) but not accounted for using the frequent shopper card (e.g., purchases at stores outside of the loyalty card program). In some examples disclosed herein, purchase data collected from the panelists utilizing both the home scanning system and one or more frequent shopper cards is used to predict purchasing behavior outside of the frequent shopper card programs (e.g., purchases made at stores without frequent shopper card programs). For example, the purchase data may be used to predict purchasing behavior for grocery accounts (e.g., which may have frequent shopper card programs) and non-grocery accounts (e.g., which may not have frequent shopper card programs). Further, examples disclosed herein may be used to predict, for example, purchase costs, buy rates, purchase occasions, market penetration, etc. associated with different brands, categories, departments, store types, etc.

An example method disclosed herein includes creating a model based on first purchase data and demographic information. The first purchase data and demographic information is associated with panelists. The first purchase data is collected via both a home scanning system and via a frequent shopper system. The example method includes applying the model to consumer data to predict second purchase data. The consumer data corresponds to consumers participating in the frequent shopper system who are not panelists of the home scanning system. The example method includes creating a report based on the application of the model to the second purchase data.

An example system disclosed herein includes a purchase information modeler to create a model based on first purchase data and demographic information. The first purchase data and demographic information is associated with panelists. The first purchase data is collected via a home scanning system and via a frequent shopper system. The example system includes a purchase behavior calculator to apply the model to consumer data to predict second purchase data. The consumer data corresponds to consumers participating in the frequent shopper system who are not panelists of the home scanning system. The example system includes a report generator to create a report based on the output of the purchase modeler.

An example tangible computer readable storage medium includes instructions that, when executed, cause a computing device to at least create a model based on first purchase data and demographic information. The first purchase data and demographic information is associated with panelists. The first purchase data is collected via both a home scanning system and a frequent shopper system. The example instructions cause the computing device to apply the model to consumer data to predict second purchase data. The consumer data corresponds to consumers participating in the frequent shopper system who are not panelists of the home scanning system. The example instructions cause the computing device to create a report based on the application of the model to the second purchase data.

FIG. 1 illustrates an example purchase modeler 102 constructed in accordance with the teachings of this disclosure to predict purchasing behavior of consumers. The example purchase modeler 102 analyzes purchasing information collected in an example home scanning system 104 and/or an example frequent shopper system 106 to predict purchasing behavior of particular consumer groups (e.g., a particular demographic constituency of consumers). Examples disclosed herein can apply to any sort of seller of goods and/or services including wholesalers, retailers, warehouse clubs (e.g., Sam's Club, Costco, etc.), online sellers, etc. In many examples below, the terms seller or merchant is used to generically refer to any type of such entity.

The example home scanning system 104 of FIG. 1 is implemented by, for example, a Nielsen Homescan® purchase data collection system. The Homescan® system is used to collect purchasing information associated with one or more panelists 108. By agreeing to participate in a panel, the one or more panelists 108 permit a monitoring entity (e.g., the Nielsen Company (US) LLC) to collect purchasing information associated with the one or more panelists 108. To collect purchasing information, the one or more panelists 108 scan purchased items (e.g., using bar codes, SKUs, etc.) at their residence or home, regardless of where such purchases were made (e.g., at different merchants such as stores, online, mail orders, etc.). Purchase information may include, for example, which items were purchased, purchase quantities, dates of purchase, merchant identification, etc. Purchase information from the scanned items is stored in association with panelist identifier information (e.g., demographic information such as age, gender, family size, income, etc.) in one or more data logs 110a at the example home scanning system 104. In some examples, the purchasing information and/or demographic information is also associated with media (e.g., television, radio, Internet) exposure information which may be collected by one or more monitoring systems and/or devices. The data collected at the individual panelist sites is uploaded to and aggregated at a central facility 118 of the monitoring entity (e.g., The Nielsen Company (US) LLC).

The example frequent shopper system 106 of FIG. 1 is used to collect point of sale (POS) purchasing information associated with one or more consumers 112 using frequent shopper card programs implementing frequent shopper cards. Stores (e.g., grocery stores) grant consumers (some of which may also be panelists of the Homescan® system) frequent shopper cards. The frequent shopper cards, for example, may be presented during check-out to enable the one or more consumers 112 to obtain one or more discounts. To collect POS purchasing information, items presented during check-out are scanned (e.g., using bar codes, SKUs, etc.) for purchase. POS purchase information from the scanned items and/or information associated with the one or more consumers 112 (e.g., demographic information) is collected and formed into one or more data logs 114a at the example frequent shopper system 106. The logs 114a collected by the frequent shopper system 106 are uploaded to the central facility 118 for analysis. The example frequent shopper system 106 may collect purchase and/or demographic information from one or more stores implementing frequent shopper programs.

Generally, there are fewer panelists 108 participating in the example home scanning system 104 than there are consumers 112 participating in the example frequent shopper system 106. Frequent shopper programs with frequent shopper cards are relatively low in cost in comparison to panelist-based systems such as the home scanning system 104. Additionally, more people are willing to participate in frequent shopper programs to obtain discounts than are willing to become panelists and scan their purchased items. Accordingly, there is generally a larger amount of POS purchase information collected by the example frequent shopper system 106 than purchase information collected by the example home scanning system 104. However, because the example frequent shopper system 106 of FIG. 1 collects purchases associated with one or more particular stores, a complete view of purchase behavior of the one or more consumers 112 is not known from the frequent shopper/loyalty card data. For example, a consumer 112 may make particular purchases at a store with a frequent shopper card program. This POS purchase information is gathered at the point of sale by the example frequent shopper system 106. However, purchases made from sellers not supporting frequent shopper programs are not known by the example frequent shopper system 106. Furthermore, the consumers may participate in different frequent shopper card programs and the panelists of those different programs may not share their data. Examples disclosed herein utilize panelist purchase data collected from one or more frequent shopper scanning panelists 116 who participate in both (1) the example home scanning system 104 and (2) the example frequent shopper system 106 to predict unknown purchasing behavior associated with one or more consumers 112 who are not panelists of the home scanning system 104. Participants in the frequent shopper system 106 who are also panelists of the home scanning system 104 are referred to herein as “frequent shopper scanning panelists” 116.

The frequent shopper scanning panelists 116 of the illustrated example participate in both the example home scanning system 104 and the frequent shopper system 106. Panelist purchase information associated with the example home scanning system 104 and/or person identifier information associated with the frequent shopper scanning panelists 116 (e.g., demographic information) is collected and formed into one or more home scanned data logs 110b by the example home scanning system 104. POS purchase information associated with the example frequent shopper system 106 and/or person identifier information associated with the frequent shopper scanning panelists 116 (e.g., demographic information) is collected and formed into one or more POS data logs 114b at the example frequent shopper system 106. The home scanned data logs 110a of the panelists 108 and the home scanned data logs 110b of the frequent shopper scanning panelists 116 may be referred to herein collectively as the home scanned data logs 110. The POS data logs 114a of the consumers 112 who are not panelists and the POS data logs 114b of the frequent shopper scanning panelists 116 may be referred to herein collectively as the POS data logs 114.

The home scanned data logs 110 are provided to an example central facility 118 by the example home scanning system 104 via a network 120. The POS data logs 114 are provided to the example central facility 118 by the example frequent shopper system 106 via the network 120. In some examples, the home scanned data logs 110 and/or the POS data logs 114 are compiled at the example central facility 118 using purchase information provided by the example home scanning system 104 and/or the example frequent shopper system 106.

The network 120 of the illustrated example may be implemented using any wired and/or wireless communication system including, for example, one or more of the Internet, telephone lines, a cable system, a satellite system, a cellular communication system, AC power lines, etc.

The purchase modeler 102 of the illustrated example is located in the example central facility 118 associated with, for example, an audience measurement entity conducting one or more studies. The central facility 118 of the illustrated example collects and/or stores demographic information and/or purchase information (e.g., the home scanned and/or POS data logs 110, 114) that is collected by the example home scanning system 104 and/or the example frequent shopper system 106. However, additional types of data (e.g., data representing exposure to media, such as content and/or advertisements, may additionally be collected. The central facility 118 may be, for example, a facility associated with a monitoring entity such as The Nielsen Company (US), LLC, an affiliate of The Nielsen Company (US), LLC or another such entity. The central facility 118 of the illustrated example includes a server 122 and a database 124 that may be implemented using any number and/or type(s) of suitable processor(s), memor(ies), and/or data storage apparatus such as that shown in FIG. 5.

The purchase modeler 102 of the illustrated example analyzes purchase information contained in the home scanned data logs 110 and the POS data logs 114 associated with the one or more frequent shopper scanning panelists 116 to predict purchasing behavior. The purchase modeler 102 of the illustrated example identifies the frequent shopper scanning panelists 116 who participate in both the example home scanning system 104 and in the example frequent shopper system 106.

The purchase modeler 102 of the illustrated example develops a model to project overall purchasing behavior by relating the home scanning information collected by the home scanning system 104 to the POS purchasing information collected by the frequent shopper system 106. In particular, the purchase modeler 102 of the illustrated example applies predictive modeling using the purchase information of the frequent shopper scanning panelists 116 and demographics of the frequent shopper scanning panelists 116 to predict purchasing behavior for purchases outside the example frequent shopper system 106 by the consumers 112. The predictive modeling may be generated using one or more of regression techniques, a decision tree, business rules, neural networks, etc. In the illustrated example, the predictive modeling reflects mathematical relationships between total purchases as reflected in the home scan data and loyalty card purchases as reflected in the frequent shopper data. In particular, the predictive modeling is used to identify mathematical relationships between the purchase information contained in the home scanned data logs 110b and the purchase information contained in the POS data logs 114b associated with the one or more frequent shopper scanning panelists 116 to predict purchasing behavior for the one or more non-panelist consumers 112.

The purchase modeler 102 of the illustrated example creates one or more reports that may include the predicted purchasing behavior (e.g., predicted overall purchasing behavior) determined using the predictive modeling analysis. For example, a report may include the predicted overall purchasing behavior for the one or more consumers 112. For example, a report may include information related to an advertiser's return on investment. In such an example, the report may include information related to an amount of money spent due to advertising for a particular product and information related to sales of that particular product. Because it employs purchasing information associated with the one or more frequent shopper scanning panelists 116 to predict purchasing behavior of the one or more non-panelist consumers 112, the report is reliable. The accuracy of the report may be enhanced by the increased number of consumers/panelists in the study. Reports created by the purchase modeler 102 of the illustrated example may include information related to money spent, purchase volume, purchase units, market penetration, purchase occasions, sale rates, etc.

FIG. 2 illustrates an example implementation of the example purchase modeler 102 of FIG. 1. The example purchase modeler 102 of FIG. 2 uses data collected from one or more home scanning systems (e.g., the home scanning system 104 of FIG. 1) and/or one or more frequent shopper systems (e.g., the frequent shopper system 106 of FIG. 1) to predict purchasing behavior of consumer group(s) (e.g., the one or more consumers 112 of FIG. 1). The purchase modeler 102 of the illustrated example develops a predictive model of purchasing behavior of consumer group(s) based on the demographic information, frequent shopper data, and the home scanning data of the frequent shopper panelists 116. The purchase modeler 102 of the illustrated example then applies the predictive model to the purchase information associated with the one or more consumers 112 to predict purchasing behavior that is not associated with sellers participating in the example frequent shopper system 106. The purchase modeler 102 of the illustrated example includes an example group identifier 202, an example scale adjustor 204, an example group ratio calculator 206, an example purchase information modeler 208, an example purchase behavior calculator 210, and an example report generator 212.

In the illustrated example, the example group identifier 202, the example scale adjustor 204, and/or the example group ratio calculator 206 are used to manipulate and/or scale data collected from one or more home scanning systems (e.g., the home scanning system 104 of FIG. 1) and/or one or more frequent shopper systems (e.g., the frequent shopper system 106 of FIG. 1). The example group identifier 202, the example scale adjustor 204, and/or the example group ratio calculator 206 may manipulate and/or scale data from the homes scanning system 104 differently than data from the frequent shopper system 106. For example, different scale adjustments may be used for different groups of data. The purchase information modeler 208 of the illustrated example creates a model using manipulated data, scales, and/or ratios from the example group identifier 202, the example scale adjustor 204, and/or the example group ratio calculator 206. The created model is based on purchasing behavior of the frequent shopper scanning panelists 116. In particular, the model reflects mathematical relationships between total purchases as reflected in the home scan data and loyalty card purchases as reflected in the frequent shopper data. The mathematical relationship(s) may indicate, for example, that consumers that buy Ivory® soap at the loyalty card stores are likely to spend X dollars per month on Ivory® soap outside the loyalty card store. The mathematical relationship(s) may also indicate, for example, that for every consumer that buys Ivory® soap at the loyalty card stores, there are Y consumers that buy Ivory® soap solely outside loyalty card stores and they spend Z dollars on their purchases. Thus, the purchase behavior calculator 210 of the illustrated example applies the model to data associated with the consumers 112 to predict purchasing behavior that is not associated with sellers participating in the example frequent shopper system 106.

The purchase modeler 102 of the illustrated example accesses demographic information and/or purchase information in the data logs (e.g., the home scanned data logs 110 and/or the POS data logs 114 of FIG. 1) stored at a database (e.g., the database 124 of FIG. 1) to predict purchasing behavior. Specifically, the purchase modeler 102 of the illustrated example uses demographic information and/or purchase information contained in the home scanned data logs 110b and the POS data logs 114b associated with the one or more frequent shopper scanning panelists 116. The demographic information identifies demographic characteristics of the frequent shopper scanning panelists 116 such as age, gender, family size, income, location, etc. The demographic information is used to identify subsets of the frequent shopper scanning panelists 116 (e.g., subsets of panelists 116 with similar demographic characteristics). The purchase information may be related to purchase metrics such as, for example, money spent, purchase rates, purchase occasions, market penetration, etc. for different products, brands, product categories, departments, store types, etc. For example, the purchase modeler 102 may predict purchase rates of a particular product for the one or more consumers 112 using purchase information associated with the one or more frequent shopper scanning panelists 116.

To analyze the purchase behavior of one or more frequent shopper scanning panelists 116 who participate in both (1) the example home scanning system 104 and (2) the frequent shopper system 106, the group identifier 202 of the illustrated example divides purchase information associated with the one or more frequent shopper scanning panelists 116 into groups. The groups may be based on where the one or more frequent shopper scanning panelists 116 make particular purchases for one or more particular products, brands, etc. as reflected in the home scanned logs 110b. In some examples, three mutually exclusive groups are used. Table 1 below describes the three mutually exclusive groups of some such examples. In this example, the table corresponds to purchases of a particular product (e.g., soap) or brand (e.g., Ivory® soap).

TABLE 1

| | Frequent Shopper System | Home Scanning System |
|---|---|---|
| | Purchases of Product or | Purchases of Product or |
| Group | Brand? | Brand? |
| 1 | Yes | Yes |
| 2 | No | Yes |
| 3 | No | No |

In some such examples, a first group of frequent shopper scanning panelists 116 is identified which includes one or more frequent shopper scanning panelists 116 who made a purchase of a particular product, brand, etc. as reflected by both the data from the example home scanning system 104 and the data from the example frequent shopper system 106. For example, a frequent shopper scanning panelist 116 associated with the first group may have purchased a particular product using a frequent shopper card and also purchased the same particular product at a different seller (e.g., without a frequent shopper card program), and scanned the particular product at home. Additionally or alternatively, the exact same purchase (made at the loyalty card store) may be reflected in both the home scan data and the POS data (i.e., a product purchased with a loyalty card is scanned by the purchaser via the Homescan system). In some examples, a second group of the one or more frequent shopper scanning panelists 116 is identified that made a purchase of the particular product, brand, etc. as reflected by data from the example home scanning system 104, but not in data from the example frequent shopper system 106. For example, a frequent shopper scanning panelist 116 associated with the second group may have purchased the particular product at a seller who does not participate in a frequent shopper card program, and then scanned the particular product at home using the home scanning system 104. In some examples, a third group of the one or more frequent shopper scanning panelists 116 is identified that did not make any purchase of the particular product, brand, etc. For example, a frequent shopper scanning panelist 116 associated with the third group did not purchase the particular product and, thus, there is no data of any such purchase in either the home scan data 110b or the POS data 114b for that frequent shopper scanning panelist 116. In some examples, the purchase modeler 102 subsequently analyzes purchase information from the home scan data logs 110b and/or the POS data logs 114b according to the groups determined at the group identifier 202.

The group identifier 202 of the illustrated example separates purchase information associated with the one or more frequent shopper scanning panelists 116 into groups to allow the purchase information to be further manipulated by the example scale adjustor 204 and/or the example group ratio calculator 206 and to be modeled at the example purchase information modeler 208. For example, adjustments and/or scaling may be made to the groups determined by the example group identifier 202 and the example purchase information modeler 208 may create a model to predict purchasing behavior for groups similar to those determined by the example group identifier 202. By separating the purchase information associated with the one or more frequent shopper scanning panelists 116 into groups, the example purchase modeler 102 of the illustrated example may more easily compare purchases made and tracked by the example home scanning system 104 to purchases made and tracked by the example frequent shopper system 106.

The scale adjustor 204 of the illustrated example calculates a scale adjustment or ratio for a particular purchase metric (e.g., money spent, buy rates, purchase occasions, market penetration, etc.) being analyzed by the example purchase modeler 102 to create a common scale for the particular purchase metric. The example scale adjustor 204 of the illustrated example is used to calculate scale adjustments or ratios related to, for example, data sampling size, product volume, time periods of purchases, discount purchases, etc.

In some examples, a scale adjustment related to data sampling size is determined by the example scale adjustor 204. In some examples, purchase metrics (e.g., purchases made using the home scanning system 104) are disparate (e.g., different from purchases made using the frequent shopper system 106). In some examples, purchase metrics (e.g., purchases made using the home scanning system 104) are disparate due to underreporting and/or misreporting by the example frequent shopper scanning panelists 116 using the example home scanning system 104. In some such examples, the scale adjustor 204 is used to equate various data sampling sizes. For example, a particular product may be purchased and tracked one hundred thousand (100,000) times using the home scanning system 104 and the same product may be purchased and tracked one thousand (1,000) times using the frequent shopper system. To analyze the product purchases, the example scale adjustor 204 calculates a ratio between the purchases of the particular product tracked at the home scanning system 104 and the purchases of the particular product tracked at the frequent shopper system 106. The example purchase information modeler 208 uses the ratio to model purchases associated with the product. For instance, the example scale adjustor 204 may determine that for every product purchased and tracked at the frequent shopper system 106, that product was purchased and tracked a particular amount at the home scanning system 104. For example, the scale adjustor 204 may determine that for every purchase made and tracked using the example frequent shopper system 106 of FIG. 1, the same product was purchased and tracked ten times using the example home scanning system 104. In other words, for a particular product, the product sold ten times as much outside of the frequent shopper system 106 as the same product sold via the merchant(s) associated with the frequent shopper system 106.

In some examples, a scale adjustment related to product size or volume is determined by the example scale adjustor 204. In some examples, the purchase modeler 102 is to analyze a particular product, but that particular product may come in various forms, sizes, or volumes. In some such examples, the scale adjustor 204 is used to equate various product sizes or volumes. For example, a beverage may be sold in two-liter bottles and packs of twelve cans. To analyze the beverage sales as a whole (e.g., to consider a single buy rate such as $8.18 per unit of a product), the example scale adjustor 204 calculates a ratio between the purchases of the different beverage volumes. The example purchase information modeler 208 uses the ratio to model purchases associated with the beverage. To determine a scale adjustment related to product size or volume, the example scale adjustor 204 uses purchase information associated with the first group or the second group discussed above in connection with the table. The example scale adjustor 204 may determine that for every product purchased at one particular volume, that product was purchased a particular amount at another volume. For example, the scale adjustor 204 may determine that for every two-liter beverage purchase made using the example home scanning system 104 of FIG. 1, the same beverage, but in packs of twelve cans, were purchased four times using the example frequent shopper system 106. In other words, for a particular beverage, packs of twelve cans sold four times as much as the same beverage in two-liter bottles. In some examples, where the purchase modeler 102 is to analyze a particular product at a particular size or volume, a scale adjustment related to product size or volume may not be determined by the example scale adjustor 204.

In some examples, a scale adjustment related to time periods of purchases is determined by the example scale adjustor 204. In some examples, the purchase modeler 102 is to analyze purchases of a particular product at different times. For example, a particular product may be purchased at one amount, but during a particular time period, that same product may be purchased at another amount. In some such examples, the scale adjustment related to time periods is used to account for disparities between purchases made at different time periods (e.g., seasons). For example, a single particular product (e.g., one bag of potato chips) may be purchased once a week and tracked using the example home scanning system 104, but a week prior to an event (e.g., the Superbowl), five (5) of that particular product may be purchased and tracked using the example frequent shopper system 106. To analyze the product purchases, the example scale adjustor 204 calculates a ratio between purchases during the different time periods. The example purchase information modeler 208 uses the ratio to model purchases associated with the product. To determine a scale adjustment related to time periods of purchases, the example scale adjustor 204 uses purchase information associated with the first group or the second group discussed above. The example scale adjustor 204 may determine that for every product purchased during one particular time period, that product was purchased a particular amount during another time period. In some examples, increased purchases may be scaled up, scaled down, and/or discredited for consistency in the modeling at the example purchase information modeler 208 (e.g., for a consistent weekly analysis).

In some examples, a scale adjustment related to discount purchases is determined by the example scale adjustor 204. In some examples, the purchase modeler 102 is to analyze purchases of a particular product that was offered at a discount. For example, a particular product may be purchased at full price at one time, but during a particular time period, that same product may be purchased at a discounted price or free as part of a sale. In some such examples, the scale adjustment related to discount purchases is used to account for disparities between purchase prices and/or disparities between actual prices paid (e.g., at a discount) by the frequent shopper scanning panelists 116 and prices (e.g., full price) reported by the frequent shopper scanning panelists 116 via the home scanning system 104. For example, a particular product may be purchased once a week and tracked using the example home scanning system 104, but during a particular week where a sale promotion was being implemented, three (3) of that particular product may be purchased and tracked using the example frequent shopper system 106. To analyze the product purchases, the example scale adjustor 204 calculates a ratio between purchases made at different sale prices. The example purchase information modeler 208 uses the ratio to model purchases associated with the product. To determine a scale adjustment related to discount purchases, the example scale adjustor 204 uses purchase information associated with the first group or the second group. The example scale adjustor 204 may determine that for every product purchased during one particular time period at a full price, that product was purchased a particular amount during another time period at a discounted price. In some examples, increased purchases may be scaled up, scaled down, and/or discredited for consistency in the modeling at the example purchase information modeler 208 (e.g., for a consistent weekly analysis). For example, products tracked by the example home scanning system 104 and/or the frequent shopper system 106 that were not actually purchased due to a discount or sale may be discredited by the example scale adjustor 204.

The example scale adjustor 204 may determine any number of scale adjustments to be used by the example purchase information modeler 208 based on the analysis to be performed by the example purchase modeler 102.

The group ratio calculator 206 of the illustrated example calculates a group ratio for the particular purchase metric being analyzed by the example purchase modeler 102. In some examples, sizes of the first group and second group may be disparate (e.g., due to misreporting and/or underreporting of the example frequent shopper scanning panelists 116), and in some such examples, the group ratio calculator 206 is used to equate various group sizes. To analyze the group sizes, the example group ratio calculator 206 calculates a ratio between sizes of the groups and the example purchase information modeler 208 uses the ratio to model purchases associated with the purchase metric. In some examples, the example group ratio calculator 206 divides a number of panelists in the second group by a number of panelists in the first group to calculate the group ratio. In some examples, the group ratio calculated by the example group ratio calculator 206 is used by the example purchase information modeler 208 to weight the purchase information of each group.

The purchase information modeler 208 of the illustrated example creates models using groupings, scales, and/or ratios from the example group identifier 202, the example scale adjustor 204, and/or the example group ratio calculator 206 in combination with demographic information to model the purchasing behavior of the one or more frequent shopper scanning panelists 116. Models created by the purchase information modeler 208 of the illustrated example are applied to purchasing data associated with the consumers 112 by the example purchase behavior calculator 210 to predict purchasing behavior associated with a variety of sellers (e.g., purchasing behavior that is not associated with sellers participating in the example frequent shopper system 106). Models created by the example purchase information modeler 208 define relationships between purchase information and demographic information associated with the frequent shopper scanning panelists 116 according to the groupings, scales, and/or ratios determined by the example group identifier 202, the example scale adjustor 204, and/or the example group ratio calculator 206. Models created by the example purchase information modeler 208 may be based on, for example, purchase sampling size, product size or volume, time periods of purchases, product discounts or sales, group size, etc. Models may be created by the example purchase information modeler 208 based on one or more particular demographic characteristics (e.g., particular genders, ages, incomes, etc.).

In some examples, the example purchase information modeler 208 creates models by combining purchase information for the first group (e.g., where a purchase made by the one or more frequent shopper scanning panelists 116 is recorded by both the example home scanning system 104 and the example frequent shopper system 106) with purchase information for the second group (e.g., where a purchase made by the one or more frequent shopper scanning panelists 116 is recorded in the example home scanning system 104, but not the example frequent shopper system 106). In some such examples, creating models using purchase information for the first group and the second group allows the example purchase information modeler 208 to account for purchases made outside of frequent shopper systems (e.g., the frequent shopper system 106).

In some examples, the example purchase information modeler 208 uses the groupings, scales, and/or ratios to weight the purchase information for the first and/or second groups. In some examples, the example purchase information modeler 208 uses purchase information associated with the first group and demographic information associated with the first group to weight purchase information for the first group, and uses purchase information associated with the second group and demographic information associated with the second group to weight purchase information for the second group. For example, purchase information associated with particular demographics (e.g., single-parent homes) may be weighted more heavily than purchase information associated with other demographics (e.g., age). The weighted purchase information for the first group and/or the second group may be used by the example purchase information modeler 208 in modeling the purchasing behavior of the one or more frequent shopper scanning panelists 116. The purchase information modeler 208 of the illustrated example creates models based on weighted purchase information using one or more of regression techniques, a decision tree, business rules, neural networks, etc. Weighting the purchase information based on, for example, demographics (e.g., gender, age, income, location, family, etc.), allows the example purchase information modeler 208 to create models that, when applied to the consumers 112, predict purchasing behavior with increased accuracy.

The purchase behavior calculator 210 of the illustrated example applies models created by the example purchase information modeler 108 to purchasing data associated with the consumers 112 to predict purchasing behavior that is not associated with sellers participating in the example frequent shopper system 106. In some examples, to predict purchasing behavior, the example purchase behavior calculator 210 identifies consumers 112 (e.g., subsets of the consumers 112) based on particular demographics of the consumers 112. For example, the example purchase behavior calculator 210 may identify a subset of the consumers 112 who are female, aged 25-35, and are unmarried.

To predict purchasing behavior of the particular subset of the consumers 112, the purchase behavior calculator 210 of the illustrated example applies a model with corresponding demographic characteristics to purchasing data of the particular subset of the consumers 112. For example, the example purchase information modeler 208 may create a model for females, aged 25-35, who are unmarried based on the frequent shopper scanning panelists 116 who comply with these demographic characteristics. The example purchase behavior calculator 210 applies the model for females, aged 25-35, who are unmarried to the consumers 112 who are female, aged 25-35, who are unmarried to generate purchasing behavior data for that particular subset of the consumers 112. The purchasing behavior data generated by the example purchase behavior calculator 210 is stored in the database 124. The example purchase behavior calculator 210 may generate purchasing behavior data associated with the consumers 112 based on one or more demographic characteristics.

In some examples, the example scale adjustor 204 determines that for a particular subset of the frequent shopper scanning panelists 116 (e.g., females, aged 25-35, who are unmarried), a particular product was purchased a first number of times (e.g., five times) via the frequent shopper systems 106 and that same particular product was purchased and reported a second number of times (e.g., nine times) via the home scanning system 104. Accordingly, in such an example, for that particular subset of the frequent shopper scanning panelists 116, for each product purchased via the frequent shopper systems 106, 1.8 units of that particular product was purchased and recorded via the home scanning system 104. In such an example, the example purchase information modeler 208 creates a model reflecting that for the particular subset of the frequent shopper scanning panelists 116 who are females, aged 25-35, and are unmarried, that particular product was purchased and recorded 1.8 times more frequently via the home scanning system 104 than the frequent shopper systems 106.

In such an example, the example purchase behavior calculator 210 calculates purchasing behavior data associated with the consumers 112 who are females, aged 25-35, and are unmarried by applying the model from the purchase information modeler 208 to purchasing data of that particular subset of the consumers 112. For example, purchasing data of the particular subset of consumers 112 (e.g., females, aged 25-35, who are unmarried) obtained from the frequent shopper systems 106 indicate that the particular subset of consumers 112 made 10,000 purchases of the particular product via the frequent shopper systems 106. In such an example, the example purchase behavior calculator 210 applies the model to the purchasing data of the subset of the consumers 112 (e.g., 10,000 frequent shopper purchases) to determine that for that particular subset of consumers 112, the particular product was purchased 18,000 times total, including purchases made outside of the frequent shopper system 106. The purchasing behavior data calculated by the example purchase behavior calculator 210 reflecting that 18,000 purchases of the particular product were made is saved and used to create reports.

The report generator 212 of the illustrated example uses the purchasing behavior data calculated by the example purchase behavior calculator 210 to create reports including purchasing behavior associated with the particular purchase metric or demographic analyzed by the purchase modeler 102 for the one or more consumers 112. For example, a report may include information related to a metric such as an advertiser's return on investment. In such an example, the report may include information related to an amount of money spent on advertising for a particular product and information related to sales of that particular product. Reports created by the report generator 212 of the illustrated example may include information related to purchase metrics such as money spent, purchase volume, purchase units, market penetration, purchase occasions, sale rates, etc. The reports may be stored in the database 124 and accessed for presentation to clients (e.g., advertisers, distributors, etc.).

While an example manner of implementing the purchase modeler 102 of FIG. 1 is illustrated in FIG. 2, one or more of the elements, processes and/or devices illustrated in FIG. 2 may be combined, divided, re-arranged, omitted, eliminated and/or implemented in any other way. Further, the example group identifier 202, the example scale adjustor 204, the example group ratio calculator 206, the example purchase information modeler 208, the example purchase behavior calculator 210, the example report generator 212, and/or, more generally, the example purchase modeler 102 of FIG. 2 may be implemented by hardware, software, firmware and/or any combination of hardware, software and/or firmware. Thus, for example, any of the example group identifier 202, the example scale adjustor 204, the example group ratio calculator 206, the example purchase information modeler 208, the example purchase behavior calculator 210, the example report generator 212, and/or, more generally, the example purchase modeler 102 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example, group identifier 202, the example scale adjustor 204, the example group ratio calculator 206, the example purchase information modeler 208, the example purchase behavior calculator 210, the example report generator 212 and/or the purchase modeler 102 are hereby expressly defined to include a tangible computer readable storage device or storage disc such as a memory, DVD, CD, Blu-ray, etc. storing the software and/or firmware. Further still, the example purchase modeler 102 of FIG. 2 may include one or more elements, processes and/or devices in addition to, or instead of, those illustrated in FIG. 2, and/or may include more than one of any or all of the illustrated elements, processes and devices.

Flowcharts representative of example machine readable instructions for implementing the purchase modeler 102 of FIGS. 1 and 2 are shown in FIGS. 3 and 4. In these examples, the machine readable instructions comprise a program for execution by a processor such as the processor 512 shown in the example processor platform 500 discussed below in connection with FIG. 5. The program may be embodied in software stored on a tangible computer readable storage medium such as a CD-ROM, a floppy disk, a hard drive, a digital versatile disk (DVD), a Blu-ray disk, or a memory associated with the processor 512, but the entire program and/or parts thereof could alternatively be executed by a device other than the processor 512 and/or embodied in firmware or dedicated hardware. Further, although the example program is described with reference to the flowcharts illustrated in FIGS. 3 and 4, many other methods of implementing the example purchase modeler 102 may alternatively be used. For example, the order of execution of the blocks may be changed, and/or some of the blocks described may be changed, eliminated, or combined.

As mentioned above, the example processes of FIGS. 3 and 4 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIGS. 3 and 4 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disc and to exclude propagating signals. As used herein, when the phrase “at least” is used as the transition term in a preamble of a claim, it is open-ended in the same manner as the term “comprising” is open ended.

A flowchart representative of example machine readable instructions for implementing the example purchase modeler 102 of FIG. 1 is shown in FIG. 3. The example purchase modeler 102 transforms purchase information associated with frequent shopper scanning panelists 116 of FIG. 1 participating in both the home scanning system 104 and the frequent shopper system 106 to predict purchasing behavior for consumers participating in the frequent shopper system (e.g., the one or more consumers 112 of FIG. 1). Initially, the example purchase modeler 102 identifies the one or more frequent shopper scanning panelists 116 who participate in both the example home scanning system 104 and the example frequent shopper system 106 (block 302). The example purchase modeler 102 obtains purchase information and demographic information contained in data logs associated with the one or more frequent shopper scanning panelists 116 (e.g., the purchase information contained in the data logs 110b and 114b) (block 304).

The example purchase modeler 102 creates a predictive model to model purchasing behavior of the frequent shopper scanning panelists 116 as a function of the home scanning data (block 306). The model created by the example purchase modeler 102 may be related to particular demographic(s) and/or particular purchase metrics such as, for example, money spent, purchase rates, purchase occasions, market penetration, etc. for different products, brands, product categories, departments, store types, etc. The example purchase modeler 102 applies the predictive model to the purchase information associated with the one or more consumers 112 to predict and/or estimate purchasing behavior that is not associated with sellers participating in the example frequent shopper system 106 (block 308).

The example purchase modeler 102 creates one or more reports including results of the modeling to provide purchasing behavior for the one or more consumers 112 (block 310). Reports created by the example purchase modeler 102 may include information related to money spent, purchase volume, purchase units, market penetration, purchase occasions, sale rates, etc. The example process of FIG. 3 then ends.

A flowchart representative of example machine readable instructions for implementing the example purchase modeler 102 of FIGS. 1 and/or 2 is shown in FIG. 4. The purchase modeler 102 of the illustrated example generates a model of purchasing behavior of consumer group(s) based on frequent shopper data as a function of the home scanning data. The purchase modeler 102 of the illustrated example applies the generated predictive model to the purchase information associated with the one or more consumers 112 to predict purchasing behavior that is not associated with sellers participating in the example frequent shopper system 106.

Initially, to analyze the purchase behavior of one or more frequent shopper scanning panelists 116 who participate in both (1) the example home scanning system 104 and (2) the frequent shopper system 106, the group identifier 202 of the illustrated example divides purchase information associated with the one or more frequent shopper scanning panelists 116 into groups (block 402). The groups may be based on where the one or more frequent shopper scanning panelists 116 make particular purchases for particular products, brands, etc. as reflected in the home scanned logs 110b. In some examples, three mutually exclusive groups are used. In some such examples, a first group is identified which includes one or more frequent shopper scanning panelists 116 who made a purchase of a particular product, brand, etc. as reflected by both the data from the example home scanning system 104 and the data from the example frequent shopper system 106. In some examples, a second group of the one or more frequent shopper scanning panelists 116 is identified that made a purchase of a particular product, brand, etc. as reflected by data from the example home scanning system 104, but not in data from the example frequent shopper system 106. In some examples, a third group of the one or more frequent shopper scanning panelists 116 is identified that did not make any purchase of a particular product, brand, etc.

The example scale adjustor 204 calculates one or more scale adjustments or ratios and the example group ratio calculator 206 calculates one or more ratios for a particular purchase metric of interest (e.g., money spent, buy rates, purchase occasions, market penetration, etc.) being analyzed by the example purchase modeler 102 (block 404). The metric of interest may be defined by inputs received from a human such as a data analyst. The example scale adjustor 204 may be used to calculate scale adjustments or ratios related to, for example, data sampling size, product volume, time periods of purchases, discount purchases, etc. The example group ratio calculator 206 may be used to calculate ratios related to disparate sizes of the groups determined by the example group identifier 202. The example scale adjustor 204 and the example group ratio calculator 206 may determine any number of scale adjustments and/or ratios to be used by the example purchase information modeler 208 based on the analysis to be performed by the example purchase modeler 102.

The example purchase information modeler 208 creates one or more models using groupings, scales, and/or ratios from the example group identifier 202, the example scale adjustor 204, and/or the example group ratio calculator 206 and demographic information to model the purchasing behavior of the one or more frequent shopper scanning panelists 116 (block 406). Models created by the example purchase information modeler 208 define relationships between purchase information and demographic information associated with the frequent shopper scanning panelists 116 according to the groupings, scales, and/or ratios determined by the example group identifier 202, the example scale adjustor 204, and/or the example group ratio calculator 206. Models created by the example purchase information modeler 208 may be based on, for example, purchase sampling size, product size or volume, time periods of purchases, product discounts or sales, group size, etc. Models may be created by the example purchase information modeler 208 based on one or more particular demographic characteristics (e.g., particular genders, ages, incomes, etc.). The example purchase information modeler 208 creates models by combining purchase information for the first group with purchase information for the second group. The example purchase information modeler 208 uses the groupings, scales, and/or ratios to weight the purchase information for the first and/or second groups. The example purchase information modeler 208 uses purchase information associated with the first group and demographic information associated with the first group to weight purchase information for the first group and uses purchase information associated with the second group and demographic information associated with the second group to weight purchase information for the second group. For example, purchase information associated with particular demographics (e.g., single-parent homes) may be weighted more heavily than purchase information associated with other demographics (e.g., age). The purchase information modeler 208 of the illustrated example creates models based on weighted purchase information using one or more of regression techniques, a decision tree, business rules, neural networks, etc.

The example purchase behavior calculator 210 applies models created by the example purchase information modeler 108 to purchasing data associated with the consumers 112 to predict purchasing behavior that is not associated with sellers participating in the example frequent shopper system 106. To predict purchasing behavior, the example purchase behavior calculator 210 identifies consumers 112 (e.g., subsets of the consumers 112) based on particular demographics of the consumers 112 (block 408). To predict purchasing behavior of the particular subset of the consumers 112, the purchase behavior calculator 210 of the illustrated example applies a model for the corresponding demographic characteristics to purchasing data of the particular subset of the consumers 112 and calculates predicted purchasing behavior data for the subset of the consumers 112 (block 410).

The predicted purchasing behavior data generated by the example purchase behavior calculator 210 for the subset of consumers 112 is stored in the database 124 (block 412). The example report generator 212 uses the predicted purchasing behavior data calculated by the example purchase behavior calculator 210 to create reports including purchasing behavior associated with the particular purchase metric or demographic analyzed by the purchase modeler 102 for the subset of consumers 112 (block 414). Reports created by the example report generator 212 may include information related to purchase metrics such as money spent, purchase volume, purchase units, market penetration, purchase occasions, sale rates, etc. The reports may be accessed for presentation to clients (e.g., advertisers, distributors, etc.). The example process of FIG. 4 then ends.

FIG. 5 is a block diagram of an example processor platform 500 capable of executing the instructions of FIGS. 3 and/or 4 to implement the example purchase modeler 102 of FIGS. 1 and/or 2. The processor platform 500 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 500 of the illustrated example includes a processor 512. The processor 512 of the illustrated example is hardware. For example, the processor 512 can be implemented by one or more integrated circuits, logic circuits, microprocessors or controllers from any desired family or manufacturer.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), and/or a PCI express interface.

In the illustrated example, one or more input devices 522 are connected to the interface circuit 520. The input device(s) 522 permit(s) a user to enter data and commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 520 of the illustrated example, thus, typically includes a graphics driver card, a graphics driver chip or a graphics driver processor.

The interface circuit 520 of the illustrated example also includes a communication device such as a transmitter, a receiver, a transceiver, a modem and/or network interface card to facilitate exchange of data with external machines (e.g., computing devices of any kind) via a network 526 (e.g., an Ethernet connection, a digital subscriber line (DSL), a telephone line, coaxial cable, a cellular telephone system, etc.).

The processor platform 500 of the illustrated example also includes one or more mass storage devices 528 for storing software and/or data. Examples of such mass storage devices 528 include floppy disk drives, hard drive disks, compact disk drives, Blu-ray disk drives, RAID systems, and digital versatile disk (DVD) drives.

The coded instructions 532 of FIGS. 3 and/or 4 may be stored in the mass storage device 528, in the volatile memory 514, in the non-volatile memory 516, and/or on a removable tangible computer readable storage medium such as a CD or DVD.

From the foregoing, it will be appreciated that methods, apparatus and articles of manufacture have been disclosed which use purchase data collected from panelists utilizing both home scanning systems and one or more frequent shopper cards to predict purchasing behavior of non-panelist consumers outside of the frequent shopper card programs (e.g., including purchases made at stores without frequent shopper card programs). Examples disclosed herein may be used to predict, for example, purchase costs, buy rates, purchase occasions, market penetration, etc. associated with different brands, categories, departments, store types, etc.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to predict purchasing behavior comprising:
creating a model based on first purchase data and demographic information, the first purchase data and demographic information being associated with panelists, the first purchase data collected via both a home scanning system and via a frequent shopper system;
applying the model to consumer data to predict second purchase data, the consumer data corresponding to consumers participating in the frequent shopper system who are not panelists of the home scanning system; and
creating a report based on the second purchase data.

2. The method of claim 1, wherein the first purchase data includes data collected by the panelists scanning purchased items at a location different than a point of sale.

3. The method of claim 2, wherein the consumer data is collected via frequent shopper cards at the point of sale.

4. The method of claim 1, wherein the model compares a first subset of the first purchase data collected via the home scanning system to a second subset of the first purchase data collected via the frequent shopper system.

5. The method of claim 1, wherein the model weights the first purchase data based on the demographic information.

6. The method of claim 1, wherein applying the model to consumer data includes identifying the consumers as having demographic characteristics similar to demographic characteristics of the panelists based on the demographic information.

7. The method of claim 1, wherein the model is created using one or more of a regression technique, a decision tree, a business rule, or a neural network.

8. A system to predict purchasing behavior comprising:
a purchase information modeler to create a model based on first purchase data and demographic information, the first purchase data and demographic information being associated with panelists, the first purchase data collected via a home scanning system and via a frequent shopper system;
a purchase behavior calculator to apply the model to consumer data to predict second purchase data, the consumer data corresponding to consumers participating in the frequent shopper system who are not panelists of the home scanning system; and
a report generator to create a report based on the second purchase data.

9. The system of claim 8, wherein the first purchase data includes data collected by the panelists scanning purchased items at a location different than a point of sale.

10. The system of claim 9, wherein the consumer data is collected via frequent shopper cards at the point of sale.

11. The system of claim 8, wherein the model compares a first subset of the first purchase data collected via the home scanning system to a second subset of the first purchase data collected via the frequent shopper system.

12. The system of claim 8, wherein the purchase modeler is to weight the first purchase data based on the demographic information.

13. The system of claim 8, wherein to apply the model to consumer data, the purchase behavior calculator is to identify the consumers as having demographic characteristics similar to demographic characteristics of the panelists based on the demographic information.

14. The system of claim 8, wherein the purchase information modeler is to create the model using one or more of a regression technique, a decision tree, a business rule, or a neural network.

15. A tangible computer readable storage medium comprising instructions that, when executed, cause a computing device to at least:
create a model based on first purchase data and demographic information, the first purchase data and demographic information being associated with panelists, the first purchase data collected via both a home scanning system and via a frequent shopper system;
apply the model to consumer data to predict second purchase data, the consumer data corresponding to consumers participating in the frequent shopper system who are not panelists of the home scanning system; and
create a report based on the second purchase data.

16. The computer readable storage medium of claim 15, wherein the first purchase data includes data collected by the panelists scanning purchased items at a location different than a point of sale.

17. The computer readable storage medium of claim 16, wherein the consumer data is collected via frequent shopper cards at the point of sale.

18. The computer readable storage medium of claim 15, wherein the model compares a first subset of the first purchase data collected via the home scanning system to a second subset of the first purchase data collected via the frequent shopper system.

19. The computer readable storage medium of claim 15, wherein the model weights the first purchase data based on the demographic information.

20. The computer readable storage medium of claim 15, wherein applying the model to consumer data includes identifying the consumers as having demographic characteristics similar to demographic characteristics of the panelists based on the demographic information.

21. The computer readable storage medium of claim 15, wherein the model is created using one or more of a regression technique, a decision tree, a business rule, or a neural network.
